(19) United States
(12) Patent Application Publication
(10) Pub. No.: US 2024/0345703 A1
(43) Pub. Date: Oct. 17, 2024

(54) Media Playback System Switcher

(71) Applicant: SONOS, INC., Santa Barbara, CA (US)

(72) Inventors: Jillian GARBER, Issaquah, WA (US); Gregory P. RAMSPERGER, Portland, OR (US)

(21) Appl. No.: 18/635,943

(22) Filed: Apr. 15, 2024

Related U.S. Application Data
(60) Provisional application No. 63/459,882, filed on Apr. 17, 2023.
(60) Provisional application No. 63/459,887, filed on Apr. 17, 2023.
(60) Provisional application No. 63/459,897, filed on Apr. 17, 2023.

(51) Int. Cl. G06F 3/0482; G06F 3/16; H04L 9/32

(52) U.S. Cl. CPC G06F 3/0482; G06F 3/165; H04L 9/3213

(57) ABSTRACT

Media playback system selection and switching techniques are disclosed. Some techniques involve receiving, from a computing system, a set of data comprising data corresponding to media playback systems registered with respective accounts. A first graphical user interface comprising graphical representations corresponding to the media playback systems can be displayed. When an input corresponding to a selection of a particular graphical representation corresponding to a particular media playback system is received via the first graphical user interface, a second user interface corresponding to the selected system can be displayed using at least part of the data received from the computing system.

### CROSS-REFERENCE TO RELATED APPLICATIONS

This application claims priority to U.S. Provisional Application No. 63/459,882, filed Apr. 17, 2023 and titled “Management of Media Playback System Splits and Location Designation for Partitions of a Media Playback System”, U.S. Provisional Application No. 63/459,887, filed Apr. 17, 2023 and titled “Multi-User Media Playback System”, and to U.S. Provisional Application No. 63/459,897, filed Apr. 17, 2023 and titled “Media Playback System Switcher”, the contents of each of which are incorporated by reference in their entirety.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 1C is a block diagram of a playback device.

FIG. 1D is a block diagram of a playback device.

FIG. 1E is a block diagram of a bonded playback device.

FIG. 1F is a block diagram of a network microphone device.

FIG. 1G is a block diagram of a playback device.

FIG. 1H is a partial schematic diagram of a control device.

FIG. 2 includes a diagram illustrating example representations of media playback systems, in accordance with embodiments described herein.

FIG. 3A illustrates a set of methods for switching between media playback systems, in accordance with some embodiments described herein.

FIG. 3B illustrates a set of methods for providing data about multiple media playback systems, in accordance with some embodiments described herein.

FIG. 4 illustrates an example graphical user interface, in accordance with some embodiments described herein.

FIG. 5 illustrates an example second graphical user interface, in accordance with some embodiments described herein.

FIG. 6 illustrates a block diagram including example implementations of some of the blocks of the methods of FIG. 3.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Media playback systems comprising a large number of distributed playback devices can be difficult to manage. One feature that could facilitate operation might be the ability to manage different parts of the media playback system independently and remotely. Additionally, it might be beneficial to allow multiple different users to manage and/or at least access certain resources of the media playback system to provide for a more distributed management/access scheme.

One example scenario in which these features might be useful could include a media playback system deployed for a business or company having multiple locations and/or multiple employees. In this scenario, it could be beneficial to provide centralized management so that at least one user (e.g., a system owner, an installer, an administrator, etc.) could manage all and/or any aspects for the entire media playback system. However, it could also be beneficial to allow for some kind of distributed management and/or access so that other users (e.g., administrators, managers, employees, etc.) are allowed to manage/access at least some aspects of the media playback system.

In certain scenarios, some users can end up being associated with more than one media playback system. For example, a user could own a media playback system at home and be an administrator for a media playback system at work. As another example, a user could be a part-time employee of two or more businesses and have access to the respective media playback systems of each business. As another example, a user could be a freelancer such as a music instructor or a dance instructor and have access to media playback systems of different studios and venues. As another example, a user could be a media playback system installer, support representative, etc. and have access to a number of media playback systems assigned to the user.

In any of the examples mentioned above and in other similar scenarios, it may be advantageous to provide a common platform via which a user could access (e.g., view, manage, control, etc.) the different media playback systems the user has access to. For example, the user could access the different media playback systems via a same media playback system application and/or web portal. In some instances, it may be advantageous to provide a platform that allows the user to access the different media playback systems without having to change accounts and/or log in into the different systems individually. At the same time, in some instances it might be advantageous to provide a platform that allows a user to access each of the media playback systems independently of the other media playback systems.

This disclosure describes mechanisms to provide a platform and/or associated user interface that allow access to multiple media playback systems and provide options for selecting and switching between media playback systems for individual access at any given time. The platform/user interface can be configured to adapt to the different media playback systems so that a user is able to individually access instances of the user interface specific to each of the media playback systems when desired. This approach could be beneficial for many reasons. As described above, the ability to access all media playback systems via a centralized platform provides a better user experience to a user of multiple media playback systems. At the same time, it may be important to provide flexibility for individual access/management to each of the multiple media playback systems. For example, it may be important to guarantee that actions intended for one media playback system do not impact other media playback systems.

However, providing this type of platform/user interface may be challenging. In some instances, at least some of the data needed to generate and/or populate such a user interface (e.g., data about the media playback systems) can be stored and/or managed by different services, and protected by a different set of authentication credentials. For example, data for each media playback system may be stored in association with the respective account to which the media playback systems are registered. In this sense, accessing the data via an account different from the account that “owns” the media playback system may bring authentication and authorization challenges.

Furthermore, in some instances, at least part of the data needed to provide such a platform (e.g., data needed to populate the user interface) may be prone to changes due to multiple factors. In some instances, those factors may be external to the account/user accessing the user interface. Since the media playback systems may not be owned and/or may not be under the control of the user accessing them, changes can happen independent of any user action and/or be outside of the user's control.

For example, the permissions granted to a user on a given media playback system may change at any time (e.g., a system owner can remove any granted permissions, add/remove permissions to specific resources, change a role for the external account so that the external account can access more or less functionalities in the system, etc.). In these instances, it may be important that the user interface reflects these changes so that the user can access the system in accordance with the most recent set of permissions. For example, it may be important that the user interface only shows resources and options that the user is currently allowed to access.

As another example, the topology of a media playback system to which a user has been granted access may change due to the addition, removal or change of resources within the system (e.g., a playback device may be moved from a location A to another location B). This change may affect the permissions that the user has in the given system. For example, if the user has been granted access to location A but not to location B, the user may no longer have access to the playback device because it is now in a location to which the user does not have access. The platform and/or user interface may need to be aware of these types of changes so that the information and options provided to the user are in accordance with the current state of each of the media playback systems. For example, after the playback device is moved to another location to which the user doesn't have access, the user interface may no longer show information about, and/or options to control, the playback device.

Embodiments described herein relate to media playback system selection and switching techniques. In some instances, a platform and/or user interface is provided that allows selection of a specific media playback system from a set of media playback systems to which the user has access. A selection of a particular media playback system via the user interface can cause the user interface to be updated to provide data and/or options exclusive to the selected media playback system and to allow the user to access, manage and/or control the selected media playback system.

At least part of the data about the various media playback systems to be used for populating the user interface can be obtained dynamically from services that manage different aspects of the data. For example, data about permissions can be obtained from one or more authorization services that manage permissions for the media playback system provider. Similarly, data about the media playback system topologies can be obtained from one or more services that manage this type of data. In this way, the user interface can be configured to provide updated information and options to the user that reflect underlying changes for each of the individual media playback systems.

The data about the various media playback systems to be used for populating the user interface can be received in aggregate or in batches from a computing system and managed locally by the device which is to provide the user interface. In some instances, the data can be filtered based on certain filtering criteria to provide different instances of the user interface. For example, data related to a particular media playback system can be filtered to provide a user interface exclusive to such particular media playback system.

Some solutions described in this disclosure may be efficient for commercial or other environments with larger media playback systems which may have a more dynamic topology and/or more dynamic set of users accessing the media playback system. Media playback systems for these types of environments may be more prone to changes to adapt and/or scale to more/less employees, more/less locations, more/less playback devices, etc. Furthermore, these types of systems may often benefit from more flexibility because resources (e.g., playback devices) and users may be added, moved, and/or removed from the system more frequently. The mechanisms described herein can be suitable for such scalable and distributed media playback systems.

In some embodiments, for example, a user device is provided. The user device comprises a display, at least one processor, and at least one non-transitory computer-readable medium comprising program instructions that are executable by the at least one processor such that the user device is configured to: transmit, to a computing system, a data request for data corresponding to partitions of media playback systems accessible by a first account of a media playback system provider; receive, from the computing system, a set of data comprising data corresponding to a set of partitions, wherein the partitions in the set of partitions comprise partitions of two or more media playback systems registered with two or more respective second accounts different than the first account, and wherein each partition comprises at least one playback device connected to a local area network (LAN) different than a LAN to which playback devices in other partitions are connected; display a first graphical user interface comprising a set of two or more first graphical representations respectively corresponding to the two or more media playback systems; receive an input corresponding to a selection of a particular graphical representation of the two or more first graphical representations, the particular representation corresponding to a particular media playback system of the two or more media playback systems; based on the input, identify a particular system identifier associated with the particular graphical representation; filter the set of data using the particular system identifier to obtain a filtered set of data; and display a second user interface, wherein the second user interface comprises a set of second graphical representations corresponding to a subset of partitions from the set of partitions, wherein the subset of partitions are partitions of the particular media playback system, and wherein the subset of partitions is indicated in the filtered set of data.

While some examples described herein may refer to functions performed by given actors such as “accounts”, “users,” “listeners,” and/or other entities, it should be understood that this is for purposes of explanation only. The claims should not be interpreted to require action by any such example actor unless explicitly required by the language of the claims themselves.

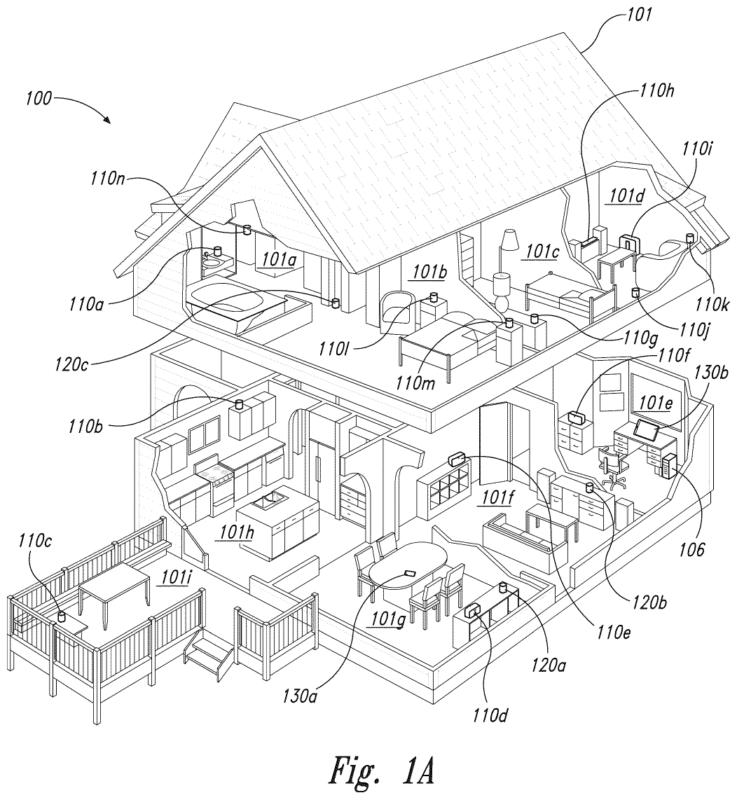

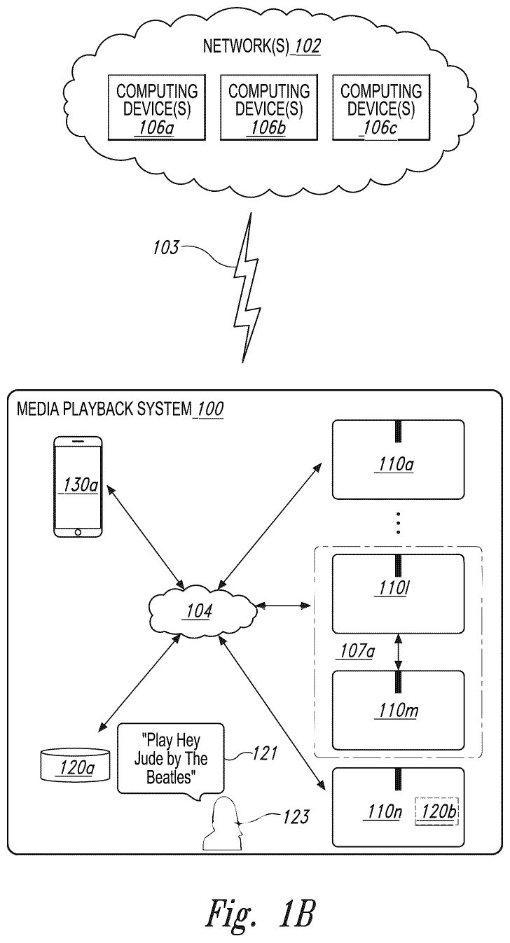

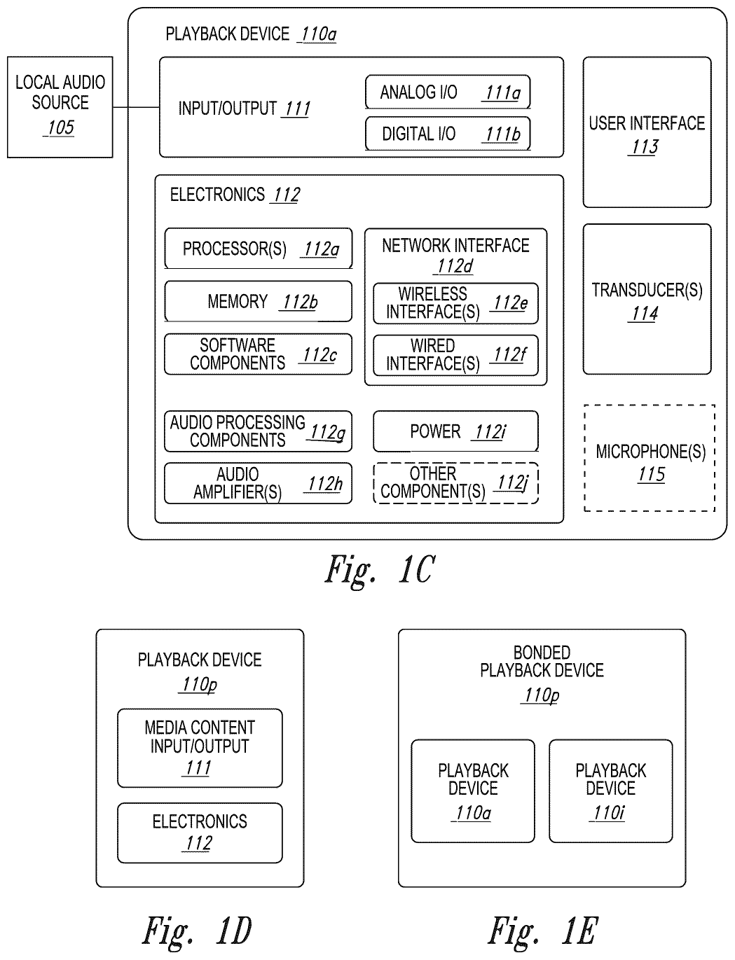

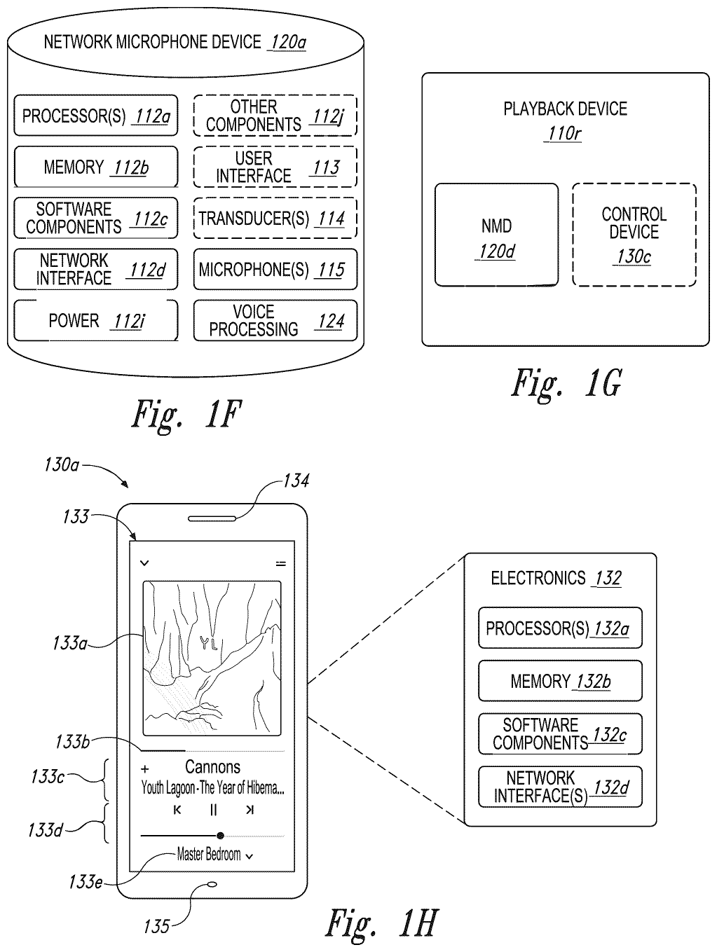

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles and other features shown in the Figures are merely illustrative of particular embodiments of the disclosed technology. Accordingly, other embodiments can have other details, dimensions, angles and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices 120 (“NMDs”) (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term “NMD” (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some embodiments, for example, the media playback system 100 is configured to play back audio from a first playback device (e.g., the playback device 100a) in synchrony with a second playback device (e.g., the playback device 100b). Interactions between the playback devices 110, NMDs 120, and/or control devices 130 of the media playback system 100 configured in accordance with the various embodiments of the disclosure are described in greater detail below with respect to FIGS. 1B-1H.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed, to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some aspects, a single playback zone may include multiple rooms or spaces. In certain aspects, a single room or space may include multiple playback zones.

In the illustrated embodiment of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B and 1E.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some embodiments, the cloud network 102 is further configured to receive data (e.g., voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHZ, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household communication network (e.g., a household WiFi network). In some embodiments, the links 103 and the network 104 comprise one or more of the same networks. In some aspects, for example, the links 103 and the network 104 comprise a telecommunication network (e.g., an LTE network, a 5G network). Moreover, in some embodiments, the media playback system 100 is implemented without the network 104, and devices comprising the media playback system 100 can communicate with each other, for example, via one or more direct connections, PANs, telecommunication networks, and/or other suitable communication links. The network 104 may be referred to herein as a “local communication network” to differentiate the network 104 from the cloud network 102 that couples the media playback system 100 to remote devices, such as cloud services.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110.

The media playback system 100 includes the NMDs 120a and 120d, each comprising one or more microphones configured to receive voice utterances from a user. In the illustrated embodiment of FIG. 1B, the NMD 120a is a standalone device and the NMD 120d is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) facilitate one or more operations on behalf of the media playback system 100.

In some aspects, for example, the computing device 106c comprises one or more modules and/or servers of a VAS (e.g., a VAS operated by one or more of SONOS®, AMAZON®, GOOGLE® APPLE®, MICROSOFT®). The computing device 106c can receive the voice input data from the NMD 120a via the network 104 and the links 103.

In response to receiving the voice input data, the computing device 106c processes the voice input data (i.e., “Play Hey Jude by The Beatles”), and determines that the processed voice input includes a command to play a song (e.g., “Hey Jude”). In some embodiments, after processing the voice input, the computing device 106c accordingly transmits commands to the media playback system 100 to play back “Hey Jude” by the Beatles from a suitable media service (e.g., via one or more of the computing devices 106) on one or more of the playback devices 110. In other embodiments, the computing device 106c may be configured to interface with media services on behalf of the media playback system 100. In such embodiments, after processing the voice input, instead of the computing device 106c transmitting commands to the media playback system 100 causing the media playback system 100 to retrieve the requested media from a suitable media service, the computing device 106c itself causes a suitable media service to provide the requested media to the media playback system 100 in accordance with the user's voice utterance.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WiFi, Bluetooth, or another suitable communication protocol. In certain embodiments, the analog I/O 111a and the digital 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communication link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). The electronics 112 are configured to receive audio from an audio source (e.g., the local audio source 105) via the input/output 111 or one or more of the computing devices 106a-c via the network 104 (FIG. 1B)), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases).

The processors 112a can comprise clock-driven computing component(s) configured to process data, and the memory 112b can comprise a computer-readable medium (e.g., a tangible, non-transitory computer-readable medium loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 excludes the network interface 112d altogether and transmits and receives media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DAC), audio preprocessing components, audio enhancement components, a digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, SONOS, Inc. presently offers (or has offered) for sale certain playback devices including, for example, a “SONOS ONE,” “PLAY:1,” “PLAY:3,” “PLAY:5,” “PLAYBAR,” “PLAYBASE,” “CONNECT:AMP,” “CONNECT,” and “SUB.” Other suitable playback devices may additionally or alternatively be used to implement the playback devices of example embodiments disclosed herein. Additionally, one of ordinary skilled in the art will appreciate that a playback device is not limited to the examples described herein or to SONOS product offerings. In some embodiments, for example, one or more playback devices 110 comprises wired or wireless headphones (e.g., over-the-ear headphones, on-ear headphones, in-ear earphones). In other embodiments, one or more of the playback devices 110 comprise a docking station and/or an interface configured to interact with a docking station for personal mobile media playback devices. In certain embodiments, a playback device may be integral to another device or component such as a television, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio components 112g (FIG. 1C), the amplifiers 114, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing 124, and only a portion of the components of the electronics 112 described above with respect to FIG. 1B. In some aspects, for example, the NMD 120a includes the processor 112a and the memory 112b (FIG. 1B), while omitting one or more other components of the electronics 112. In some embodiments, the NMD 120a includes additional components (e.g., one or more sensors, cameras, thermometers, barometers, hygrometers).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input) without a separate control device. In other embodiments, however, the playback device 110r receives commands from another control device (e.g., the control device 130a of FIG. 1B).

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing 124 receives and analyzes the microphone data to determine whether a voice input is present in the microphone data. The voice input can comprise, for example, an activation word followed by an utterance including a user request. As those of ordinary skill in the art will appreciate, an activation word is a word or other audio cue signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing 124 monitors the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

d. Suitable Control Devices

FIG. 1H is a partial schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™, an Android phone) on which media playback system controller application software is installed. In some embodiments, the control device 130a comprises, for example, a tablet (e.g., an iPad™), a computer (e.g., a laptop computer, a desktop computer), and/or another suitable device (e.g., a television, an automobile audio head unit, an IoT device). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 302 to perform those functions. The software components 132c can comprise applications and/or other executable software configured to facilitate control of the media playback system 100. The memory 112b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 304 to one or more of the playback devices 100. The network interface 132d can also transmit and/or receive configuration changes such as, for example, adding/removing one or more playback devices 100 to/from a zone, adding/removing one or more zones to/from a zone group, forming a bonded or consolidated player, separating one or more playback devices from a bonded or consolidated player, among others.

The user interface 133 is configured to receive user input and can facilitate control of the media playback system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound) and/or configured to facilitate filtering of background noise. Moreover, in certain embodiments, the control device 130a is configured to operate as playback device and an NMD. In other embodiments, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones.

### III. Media Playback System Switching Techniques

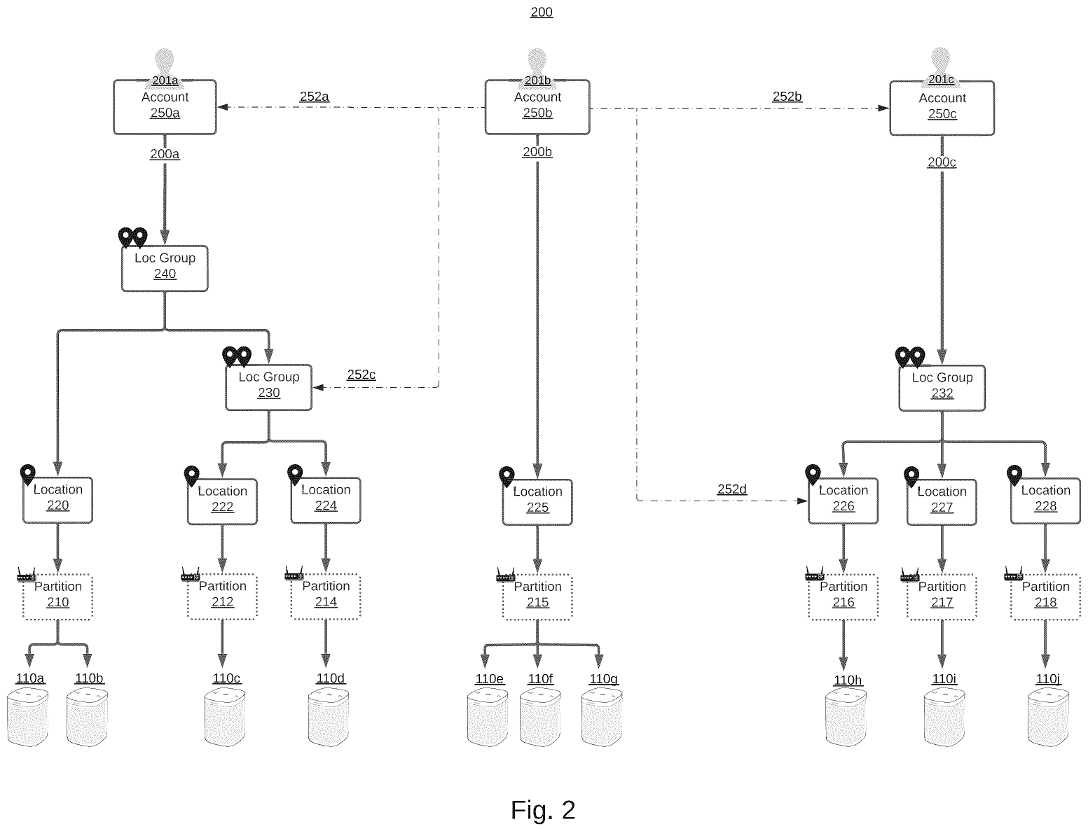

FIG. 2 includes a diagram 200 illustrating example topology representations of media playback systems 200a, 200b and 200c (collectively referred to as media playback systems 200), in accordance with embodiments described herein. In some instances, some or each of the media playback systems 200 can be the same or similar to any of the media playback systems 100 described with reference to FIGS. 1A-1H. In some instances, some or each of the media playback systems 200 can be the same or similar to any of the media playback systems described in U.S. Provisional Application No. 63/459,882, filed Apr. 17, 2023 and titled “Management of Media Playback System Splits and Location Designation for Partitions of a Media Playback System” and U.S. patent application Ser. No. 18/635,422, filed Apr. 15, 2024, and titled “Management of Media Playback System Splits and Location Designation for Partitions of a Media Playback System,” the contents of each of which are incorporated by reference in their entirety. In some instances, some or each of the media playback systems 200 can be the same or similar to any of the media playback systems described in U.S. Provisional Application No. 63/459,887, filed Apr. 17, 2023 and titled “Multi-User Media Playback System” and U.S. patent application Ser. No. 18/635,595, filed Apr. 15, 2024 and titled “MULTI-USER MEDIA PLAYBACK SYSTEM,” the contents of each of which are incorporated by reference in their entirety.

The media playback system can comprise any number of playback devices, such as playback devices 110a, 110b, 110c, 110d of system 200a, playback devices 110e, 110f, 110g of system 200b, and playback devices 110h, 110i, 110j of system 200c, collectively referred to as playback devices 110. In some instances, the media playback systems described in this disclosure can comprise (or be split into) two or more partitions (e.g., partitions 210, 212, 214 of system 200a, partition 215 of system 200b, and partitions 216, 217 and 218 of system 200c). A partition, as used herein, refers to a set of one or more playback devices that are connected to the same LAN. In this way, a media playback system can be said to be split when one or more playback devices are connected to a different LAN(s) than other playback devices in the media playback system.

In some instances, when playback devices are in different partitions, they can be considered to be in different locations (e.g., locations 220, 222, 224 of system 200a, location 225 of system 200b, and locations 226, 227, and 228 of system 200c). In some instances, two or more partitions of the media playback system can be associated with a same location. A “location”, as used herein, refers to and/or identifies a collection of playback devices, regardless of the actual physical location where the devices are at and/or the LAN to which the devices are connected. It should be understood that the term “location”, as used in this disclosure, does not indicate a particular place or position. To avoid confusion, the term “physical location” or “place” will be used, if necessary, to refer to a particular place or position. Additional details regarding system's partitions and locations can be found in U.S. Provisional Application No. 63/459,882, filed Apr. 17, 2023, and titled “Management of Media Playback System Splits and Location Designation for Partitions of a Media Playback System” and U.S. patent application Ser. No. 18/635,422, filed Apr. 15, 2024, and titled “Management of Media Playback System Splits and Location Designation for Partitions of a Media Playback System.”

In some instances, locations can be grouped into location groups (e.g., location group 230 of system 200a and location group 232 of system 200c). Location groups can in turn be grouped with other location groups and/or other locations (e.g., location group 240 of system 200a). In this way, a media playback system can be organized in accordance with a hierarchical topology comprising multiple levels and branches, such as the topologies illustrated with the example systems 200.

The example topologies illustrated in FIG. 2 are for explanatory purposes only. Any number of nodes (e.g., playback devices, partitions, locations, location groups, etc.) can exist for a media playback system in accordance with this disclosure. Furthermore, each partition/location can include any number of playback devices. The diagram 200 of FIG. 2 will be used as a reference for various examples given in this disclosure. However, this diagram will be used for explanatory purposes only. The contents described in this disclosure can be broadly applicable to any other scenario and systems. Furthermore, although three media playback systems are illustrated in this example, any number of media playback systems could be involved.

As illustrated in FIG. 2, the media playback systems 200 can each be registered with respective media playback system provider accounts 250a, 250b, and 250c (collectively referred to as accounts 250). The accounts 250 can be associated with (e.g., belong to) respective users 201a, 201b, 201c (collectively referred to as users 201). In some instances, some or each user 201 can comprise any type of entity such as a person, a business, a company, etc. The media playback systems 200 can be registered with respective accounts 250 so that the media playback systems and all constituent resources (e.g., playback devices 110) are associated with/mapped to such account. This association can be created by having a system identifier of the respective system associated with the respective account and assigned to each device in the media playback system to register the devices to the respective account. The association could also be created by having a user and/or account identifier directly associated with the devices. Other options are possible. Example registration procedures are described in U.S. Patent Pub. No. 2022/0104015, filed Sep. 24, 2021, entitled “Intelligent Setup for Playback Devices”, which is incorporated by reference in its entirety.

In some instances, users and/or their respective accounts can be associated with (e.g., have access to) more than one media playback system so that one user/account has access to more than one media playback system. For instance, a first account, such as account 250b in the example illustrated in FIG. 2, can be associated with one or more second accounts and/or media playback systems, such as accounts 250a and/or 250c and/or media playback systems 200a and/or 200c. Examples of how additional accounts can be associated with other accounts/media playback systems are described in U.S. Provisional Application No. 63/459,887, filed Apr. 17, 2023 and titled “Multi-User Media Playback System” and U.S. patent application Ser. No. 18/635,595, filed Apr. 15, 2024 and titled “MULTI-USER MEDIA PLAYBACK SYSTEM,” the contents of each of which are incorporated by reference in their entirety.

In some instances, a first account can be associated with (and/or be granted access to) a second account so that the first account can access a media playback system registered with the second account. The accounts can be associated, for example, via an invitation received from the second account, as explained in U.S. Provisional Application No. 63/459,887, filed Apr. 17, 2023 and titled “Multi-User Media Playback System” and U.S. patent application Ser. No. 18/635,595, filed Apr. 15, 2024 and titled “MULTI-USER MEDIA PLAYBACK SYSTEM,” the contents of each of which are incorporated by reference in their entirety. In the example illustrated in FIG. 2, an association between a first account 250b and second accounts 250a and/or 250c is illustrated with arrows 252a and 252b, respectively. In these examples, the arrows indicate that the first account 250b has access (e.g., has been granted access) to the other two second accounts 250a and 250c. This association can be stored and relied on to determine whether the first account has access to the second account/system. The association can be created by generating or updating a data structure (e.g., a row in a table, an object in a database, etc.) to store a first account identifier of the first account in association with a second account identifier of the second account. In some instances, a first account can be associated directly with (and/or be granted access to) the media playback system registered with the second account, rather than or in addition to being associated with the second account itself (e.g., by storing an association of the first account identifier with a system identifier of the system to which the first account is associated and/or has access).

In some instances, the first account can be associated with (and/or be granted access to) specific resources in the media playback system. In the example illustrated in FIG. 2, an association between the first account 250b and specific resources of system 200a (location group 230) is illustrated with arrow 252c. Additionally, an association between the first account 250b and specific resources of system 200c (location 226) is illustrated with arrow 252d. In these examples, the arrows indicate that the first account 250b has access (e.g., has been granted access) to specific resources. In this way, the first account 250 may only have access to the resources it is associated with (and/or has been granted access to). This association can be stored and relied on to determine whether the first account has access to a particular resource. The association can be generated by generating or updating a data structure (e.g., a row in a table, an object in a database, etc.) to store a first account identifier in association with a resource identifier.

As illustrated in the example of FIG. 2, there can be instances in which the first account 250b is registered with a media playback system, such as system 200b, in addition to any media playback systems to which the first account 250b is granted access to (e.g., in addition to systems 200a and/or 200c registered with accounts 250a and 250c respectively). Media playback system 200b could be, for example, a media playback system owned by user 201b and/or registered with account 250b. In other instances, the first account 250b may not have any media playback system registered with it. In this way, the first account can be an account with the media playback system provider with no resources registered directly with it.

In the example of FIG. 2, media playback systems 200a and 200c could represent, for example, media playback systems of two different businesses 201a and 201c. User 201b could be an employee of the two businesses or otherwise a user with access to both systems (e.g., an installer, a support representative, a system administrator, a client, etc.). Although the example of an employee of two businesses will be used for explanation purposes, other scenarios are possible. For example, any of the second accounts 250a/250c and/or systems 200a/200c could be media playback systems of friends and family of user 201b. User 201b can be associated with those systems so that user 201b can access their system, play back content, troubleshoot issues, configure the system, etc. As another example, user 201b could be a DJ, a dance, fitness, or music instructor, or any kind of professional who works at different places/venues and has access to multiple media playback systems of the different places/venues.

In some instances, the first account 250b and/or respective user 201b may be able to view and manage certain aspects of the media playback systems they have access to. For example, data and/or options to control certain functionalities of the media playback systems could be provided to the first account via a user interface. In some instances, the user interface comprises a graphical user interface. In some instances, the user interface comprises any other type of user interface such as an audio/voice user interface. The user interface can be provided by/via a device (e.g., a user device) registered with and/or with access to the first account. The user interface can be provided via an application (e.g., a controller application) running on the user device, and/or via a web portal and/or any other suitable means. In some instances, the user interface comprises a dashboard user interface such as the dashboard ser interface described in U.S. Prov. Pat Application No. 63/459,909, filed Apr. 17, 2023, entitled “Dashboard User Interface” and U.S. patent application Ser. No. 18/430,160, filed Feb. 1, 2024, entitled “Dashboard User Interface”, the contents of each of which are incorporated by reference in their entirety. The user interface can be configured to allow a user to view and/or control aspects of the media playback systems, in accordance with any role and/or granted permissions for the user.

Each media playback system may have individual characteristics. For example, each media playback system may have a different number and distribution of resources, different system configurations, access to different services (e.g., media streaming services), etc. Furthermore, the first account 250b may have different permissions for each of the media playback systems it has been granted access to. In some instances, the first account 250b and/or respective user 201b may need a mechanism to view and manage each system individually in accordance to each system's individual characteristics and permissions, and/or a mechanism to switch between all the media playback systems they have access to.

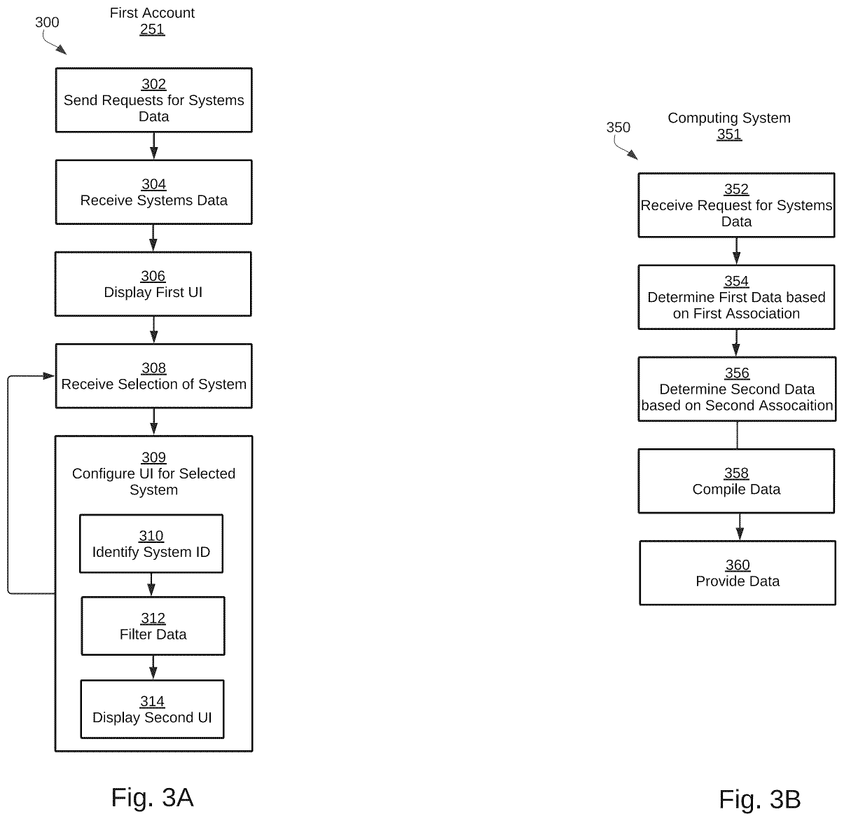

FIG. 3A illustrates a set of methods for selecting and switching between media playback systems via a user interface, in accordance with some embodiments described herein. Method 300 can be performed by/via a first account such as account 250b and/or by any device with access to the first account, such as a user device of a user of the first account. In some instances, some or all of the steps of method 300 can be performed by any device registered with the first account and/or any device through which such first account can be accessed. In some instances, the first account can be accessed via a user device such as a smartphone, a computer, etc. For example, the first account could be accessed using a set of credentials or other authentication mechanisms, via an application installed on the user device. As another example, the first account can be accessed via a web portal/web user interface.

Method 300 includes a block 302 of transmitting one or more data requests for data corresponding to the media playback systems with which the first account is associated and/or to which the first account has access. In some instances, the data requests comprise requests to “discover” and/or “find” what accounts, systems and/or resources the first account has access to. In some instances, the requests are transmitted to a computing system able to generate/obtain the data requested in the data requests, as will be described below in more detail with reference to FIG. 3B.

The data requests can be sent in one or more messages. The one or more messages can include any data such as data identifying the first account. In some instances, the requests include an identifier of the first account, a user identifier, or any other identifier that serves to uniquely identify the first account. In some instances, the requests comprise a token of the first account that unambiguously identifies and/or authenticates the first account. In some instances, the requests comprise Application Programming Interface (API) calls between the first account (and/or a device registered with the first account) and a service/computing system storing/managing the data. In some instances, the requests comprise an API key for the APIs.

In some instances, the data request comprises a request to “discover” the users and/or accounts with which the first account is associated. An example of this type of request is shown as follows:

ET /authz/v1/authorization/discovery
Headers:
Authorization: Bearer { Token }

An example response to this type of request is shown as follows:

```
{
  “targets”: [
    {
      “role”: “OWNER”,
      “targetId”: “1122334455”,
      “targetType”: “users”,
        “Entitlements” : { }
    },
    {
      “role”: “ADMIN”,
      “targetId”: “5566778899”,
      “targetType”: “users”,
        “Entitlements” : { }
    }
      ]
}
```

In some instances, the data request comprises a request to “discover” the media playback systems (“households” in this example) with which the first account is associated. An example of this type of request is shown as follows:

```
[
  {
    “namespace”: “households:1”,
    “command”: “get”
  },
  { }
]
```

An example response to this type of request is shown as follows:

```
[
  {
    “namespace”: “households:1”,
    “response”: “get”,
    “success”: true,
    “type”: “households”
  },
  {
    “households”: [
      {
        “id”: “Sonos_00000000000000000000000001”
        “name”: “Home”
      },
      {
        “id”: “Sonos_00000000000000000000000002”,
        “name”: “Office”
      }
    ]
  }
]
```

In some instances, the data request comprises a request to “discover” specific resources in the media playback systems (e.g., locations/partitions, playback devices, etc.) with which the first account is associated. An example of this type of request is shown as follows:

GET /locations
“X-Sonos-User-Id”: “userId”

An example response to this type of request is shown as follows:

```
{
  “collection”:[
    {
      “userid”:“123345”,
      “locations”:[
        {
          “id”:“lc_333”,
          “metadata”:{
            “name”:“myname1”
          },
          “parentId”:“lc_444”,
          “children”:[
            {
              “id”:“idValue”,
              “type”:“HOUSEHOLD”,
              “affiliationAt”:“2022-09-27T15:17:48Z”,
              “networkHash”:“hashValue”
            }
          ]
        },
        {
          “id”:“lc_667”,
          “metadata”:{
            “name”:“myname2”
          },
          “parentId”:“lc_888”
        }
      ]
    },
    {
      “userid”:“2468”,
      “locations”:[
        {
          “id”:“lc_999”,
          “metadata”:{
            “name”:“myname1”
          },
          “parentId”:“lc_111”,
          “children”:[
            {
              “id”:“idValue”,
              “type”:“HOUSEHOLD”,
              “affiliationAt”:“2022-09-27T15:17:48Z”,
              “networkHash”:“hashValue”
            }
          ]
        },
        }
          “id”:“lc_3434”,
          “metadata”:{
            “name”:“myname2”
          },
          “parentId”:“lc_4343”
        }
      ]
    }
  ]
}
```

Requests such as the request(s) sent in block 302 can be sent at any time. In some instances, the request(s) can be sent any time the first account is accessed (e.g., upon/after login, when an application or web portal associated with the first account is in the foreground/open, etc.). In some instances, the request(s) can be sent periodically at a certain frequency so that the first account has the most up to date data. The frequency of the requests can be configurable, for example by a system administrator. In some instances, the request(s) can be sent when the first account detects a change (for example when the first account is invited/uninvited to access a media playback system). In some instances, the request(s) can be sent in response to an event, such as in response to an input received via a user interface. The input could comprise interactions with the user interface, such as an input received via an indication to display information about the media playback systems/accounts that the first account has access to.

Method 300 includes a block 304 of receiving a set of data comprising data corresponding to the media playback systems, accounts and/or resources that the first account has access to (e.g., depending on the data requested in block 302). For example, the set of data could include data corresponding to the set of systems 200a and 200c and/or set of accounts 250a and 250c to which the first account 250b has access. The set of data could include data corresponding to any specific resource such as a set of partitions of the set of media playback systems 200a and 200c. The set of data could be received from the computing system. In some instances, the set of data can be received in response to or otherwise based on the data request sent in block 302. In some other instances, the set of data can be received regardless of any request sent in block 302 (e.g., the computing system may automatically send data to the first account). For example, the first account could “subscribe” and/or request to receive updates from the media playback system when there are changes to the data, and/or at a certain frequency or period of time, etc. In some instances, the set of data received in block 304 comprises “raw” data that can be processed locally on the receiver device for various purposes.

Receiving the set of data in block 304 could include receiving any of the example API responses described above. In some instances, the set of data includes a list of resources to which the user has access to, such as a list of users, accounts, media playback systems, partitions/locations of a media playback systems, etc. The set of data can include any resources the user/account owns (e.g., resources registered with the first account) and/or any resources to which the user/account has been granted access (e.g., resources to which the first account has been granted access). For example, the set of data could include a list of partitions such as partitions 212, 214, 215, and 216 to which the first account 250b has access. The set of data could be obtained/generated by the computing system in various ways, as will be described in more detail below with reference to FIG. 3B.

Method 300 includes a block 306 of displaying a first graphical user interface. This first graphical user interface can comprise a set of graphical representations corresponding to the media playback systems to which the first account has access. In some instances, this graphical user interface could be displayed based on any of the data received in block 304. In some instances, this graphical user interface could be displayed independently of any data received in block 304, for example can be displayed based on data otherwise available to the first account (e.g., locally stored data, cached data and/or data stored on cookies).

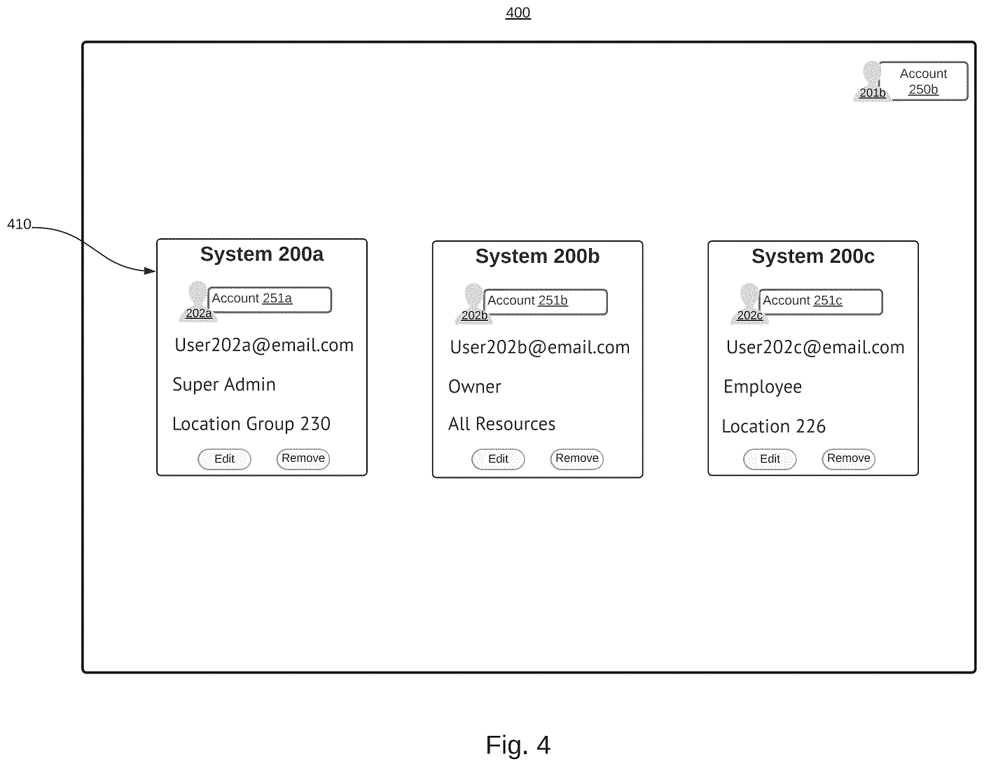

FIG. 4 illustrates an example graphical user interface that could be displayed as a result of the execution of block 306. As illustrated, the user interface 400 can comprise graphical representations such as graphical representation 410 corresponding to any media playback system to which the first account has access. The graphical representations can comprise or be displayed together with any data, for example data that may help identify the corresponding system, such as system name, a system identifier, an account identifier, an account owner name, an icon, a picture, etc. The data could also include any other data such as a role (e.g., Super Admin, Owner, Employee, etc.) that the first account has for each of those systems, an indication of how many and/or what resources the first account has access to in each system, etc. In some instances, the systems represented in the user interface 400 can be associated with entities such as a business. The business name (or any other system name) can be displayed to identify the systems. In this way, the user could select/switch between “businesses” (i.e., switch between media playback systems associated with different businesses).

In some instances, the graphical user interface generated in block 306 may include graphical representations corresponding to all media playback systems to which the first account has access. In some instances, the graphical user interface generated in block 306 may include graphical representations corresponding to only a subset of media playback systems to which the first account has access, and exclude graphical representations corresponding to some of the systems to which the first account also has access. For example, the user interface may be configured to display only graphical representations for system to which the user/first account has been granted access, but not systems owned by the user/registered with the first account. In this way a personal media playback system could be excluded or hidden from a professional or business user interface. As another example, a user could select the media playback systems to be shown/hidden from the graphical user interface. As another example, the media payback systems to be displayed can be selected based on contextual data such as a place or time of the day so that only media playback systems relevant to the context are displayed. Similarly, media payback systems to be displayed can be selected based on past user behavior and/or routines.

In some instances, the media playback systems represented in the user interface are selected based on certain criteria, such as whether the systems are personal or business/professional, or based on a user role for the systems (e.g., user interface could show only systems in which the user is an employee but not the systems in which the user is a guest). In some instances, the data received in block 304 of flowchart 300 comprises an indication of a type of system for each media playback system. The systems selected for display in the graphical interface may be based on such type of system. The type of system may comprise a category of systems (e.g., consumer, business, etc.).

Method 300 includes a block 308 of receiving an input corresponding to a selection of a particular graphical representation corresponding to a particular media playback system. The selection can be received directly via the graphical user interface (e.g., graphical user interface 400), for example by selecting the graphical representation (e.g., 410) via a touch screen or by clicking on the representation using a cursor. At this point, one or more data requests such as the data requests sent in block 302 could be sent to the computing system to obtain data corresponding to the selection. However, in some instances, additional data requests may not be necessary at this point. The first account may be able to mine the data corresponding to the selection from any set of data already received in block 304. In any case, the user interface could be updated to present data associated with the selected system.

Method 300 includes a block 309 of configuring the user interface based on the selected system. This block could include either updating the previous user interface or generating a new one. The new/updated user interface may include information related to the selected system (e.g., status information, playback controls or other controls, etc.). In some instances, the new/updated user interface excludes any information related to the other non-selected system.

Block 309 can optionally include a block 310 of identifying a particular system identifier associated with the particular graphical representation selected in block 308. This block can include searching for data mapped to a specific set of touch/click coordinates, or mapped directly to the graphical representations. For example, code corresponding to each graphical representation can include such data. The system identifier could be identified directly from the data associated with the graphical representation or indirectly, for example by using other data (e.g., a pointer, a name, a memory address, etc.). The system identifier could be used to adapt the user interface to the corresponding media playback system.

Block 309 can optionally include a block 312 of filtering the set of data. The set of data to be filtered can include any data received in block 304. The set of data can be filtered so that the filtered set of data obtained in block 312 comprises data corresponding to only one of the media playback systems. In some instances, the set of data can be filtered using the particular system identifier identified in block 310. In this way, the filtered set of data can comprise data associated with the particular system/system identifier and exclude data associated with other systems/system identifiers.

Block 309 can optionally include a block 314 of displaying a second user interface. The second user interface can be based, at least in part, on the filtered set of data obtained in block 312 so that it reflects information of one particular media playback system (i.e., the media playback system selected in block 308). In some instances, the second user interface comprises a set of second graphical representations corresponding to resources of the particular media playback system. For example, the second user interface can comprise a set of second graphical representations corresponding to locations and/or partitions of the particular media playback system. The locations/partitions in the second graphical user interface can be a subset of locations/partitions included in the filtered data set, from the whole set of locations/partitions included in the set of data received in block 304.

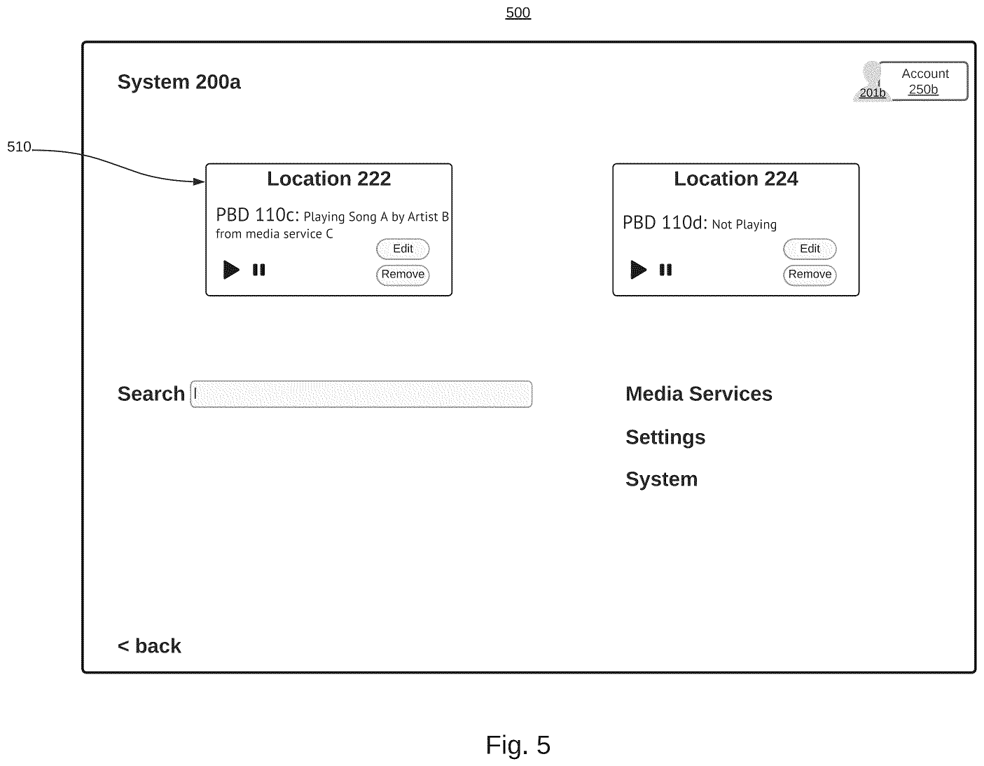

In this way, the first account and/or any user device being used to access the first account can be configured to select and/or switch between media playback systems to view/manage each media playback system individually. FIG. 5 illustrates an example second graphical user interface that can be displayed as a result of the execution of block 309. As illustrated, this user interface can include graphical representations, such as graphical representation 510, corresponding to resources of the selected system that are accessible to the user. In this example, system 200a has been selected.

The example user interface 500 includes graphical representations 510 for locations 222 and 224 and corresponding playback devices 110c and 110d. The example user interface 500 excludes, however, any graphical representations corresponding to other resources in system 200a (such as location 220 and corresponding playback devices 110a and 110b) to which the user/first account has not been granted access. Similarly, if a new location were to be created under location group 230, the user interface could reflect this change by showing a graphical representation of the new locations and/or any playback devices in the new location. The user would then have access to the new resources via the user interface without having to take any further action. The new location would be presented to the user based on the user granted permissions on location group 230 and based on an update to the topology of system 200a that would indicate that the new location is under such location group.

In this way, the user interface can reflect the permissions and level of access that the user has on the selected system at a given time, not showing any information or options for allowing the user to access resources to which the user doesn't have access to. Furthermore, the options provided in the user interface (e.g., playback controls, options to search content, options to see and/or edit settings, etc.) may be curated depending on the user's permissions and/or role on the given system. For example, a user may be able to control playback on system 200a, but not on system 200c. In this way, a user interface for system 200c may not show any playback controls.

The system identifier corresponding to the selected system (e.g., the identifier determined in block 310 of flowchart 300) can be used to perform subsequent actions in the system, such as to obtain additional data and/or to access a media streaming service for the media playback system, which may be associated with the account to which the system is registered. In some instances, when a particular system is selected, an identifier for the system and/or for the account under which the system is registered can be used for certain purposes (e.g., to access a voice assistant associated with the system owner rather than with the user logged into the user interface), and an identifier of the user/account logged in to the user interface can be used for other purposes (such as to make other data request and/or control a resource).

Using the filtered set of data obtained in block 312 of flowchart 300, many other aspects of the user interface could be adapted to the selected system. For example, a subset of user interfaces can be modified so that they are populated with data from the set of data to reflect information about the particular system. Each media playback system may be associated with a similar set of user interfaces (e.g. a framework or template). Such framework can be populated with data from the set of data as filtered for each media playback system so that whenever a system is selected, the interfaces are generated/or and adapted to such system. This process can be performed on the fly by processing (e.g., filtering) the “raw” data obtained from the computing system. This mechanism provides a way of switching between systems quickly and efficiently.

As illustrated in flowchart 300, a selection of a media playback system in block 308 can happen at any time (e.g., after another system has been selected and the user interface configured accordingly in block 309). For example, the user interface 500 can provide an option to select and/or switch to another media playback system and/or an option to go back to a user interface such as user interface 400, from which another system can be selected. This switch can happen almost instantaneously by processing the data already available (e.g., by conducting blocks 310-314 of method 300 based on the data received in block 304). In this way, if the user wanted to do a quick status check of all the systems the user has access to, they could do so by switching between systems effectively, leveraging the fact that the account and/or respective device are already in possession of the data. In some instances, at least part of the data for the newly selected system can be requested to the computing system by performing some or all of the blocks 302-309. This data can be used alone or in combination with any data previously receive to generate the user interface for the newly selected system.

A user may be able to access any of the media playback systems they have access to remotely via the user interfaces described above. The media playback systems and respective resources (e.g., locations and/or partitions associated with different LANs) may be accessed over a WAN so that the user does not need to be on the same LAN as the resources. In some instances, however, the user/user device may be required to be connected to the same LAN as the resources in order to access such resources. Access to the different resources can occur via one or more intermediary devices and/or computing systems. Access to the different resources may be verified by one or more access control mechanisms. Examples of how to handle user access requests are described in U.S. Provisional Application No. 63/459,887, filed Apr. 17, 2023, and titled “Multi-User Media Playback System” and U.S. patent application Ser. No. 18/635,595, filed Apr. 15, 2024, and titled “MULTI-USER MEDIA PLAYBACK SYSTEM,” the contents of each of which are incorporated by reference in their entirety.

FIG. 3B includes a flowchart 350 for a set of methods of providing data about multiple media playback system that are accessible to an account. Method 350 can be performed by a computing system 351. The computing system 351 can comprise one or more computing devices. The computing devices can be any device comprising one or more processors and non-transitory computer-readable media comprising program instructions that are executable by the one or more processor such that the computing system is configured to conduct the methods described herein. In some instances, the computing devices comprise a user device, such as a smart phone or computer. In some instances, the computing devices comprise any of the devices in the media playback system, such as a control device, a playback device, etc. In some instances, the computing devices comprise a remote computing device such as a remote server and/or cloud computing device. In some instances, the computing devices can be any of the computing devices 106 described with reference to FIGS. 1A-1H. In some instances, the computing system 351 comprises any one or combination of computing devices described above or anywhere else in this disclosure. In some instances, the computing system comprises one or more user devices registered with and/or with access to a main account, one or more user devices registered with and/or with access to an additional account, and optionally one or more intermediary devices such as one or more computing systems.

Method 350 includes a block 352 of the computing system receiving a data request. The data request can be the data request(s) sent in block 302 of method 300. Although it is represented by a single block at the beginning of the flowchart, the computing system could receive data requests such as the data requests described with reference to block 302 at any time and any number of times. The computing system could determine (e.g., obtain and/or generate) the data requested in the data request via one or more associations accessible to the computing system.

In some instances, the computing system determines certain data based on/using a first association, as indicated in block 354. This first association can include associations between the first account and any other accounts (e.g., mappings/tables/data structures mapping a first account identifier and additional account identifiers). The first association could also or alternatively include associations between the first account and the media playback systems it has access to (e.g., mappings/tables/data structures mapping a first account identifier and system identifiers of the respective systems). The first association could also or alternatively include associations between the first account and specific resources of the media playback systems to which the first account has access (e.g., mappings/tables/data structures mapping a first account identifier and identifiers of resources of the respective systems such as location identifiers, playback devices identifiers, etc.). In some instances, the first association comprises any explicit grants to the first account and/or any data that could be used to determine such explicit grants. Explicit grants include any permissions explicitly granted to the user (e.g., represented by arrows 252a, 252b, 252c, and 252c in the example of FIG. 2). Explicit grants are explained in more detail in U.S. Provisional Application No. 63/459,887, filed Apr. 17, 2023, and titled “Multi-User Media Playback System” and U.S. patent application Ser. No. 18/635,595, filed Apr. 15, 2024, and titled “MULTI-USER MEDIA PLAYBACK SYSTEM,” the contents of each of which are incorporated by reference in their entirety.

In some instances, the computing system determines certain data based on/using a second association, as indicated in block 356. The second association can include associations between any of the accounts associated with the first account and the respective media playback systems registered with those accounts. The second association could also or alternatively include associations between the accounts/media playback systems associated with the first account and specific resources in those media playback systems. The second association could also or alternatively include associations between various resources in the media playback systems to which the first account has access. In some instances, the second association comprises the topologies of the media playback systems to which the first account has access. In some instances, the second association comprises any permissions (e.g., explicit/implicit grants) granted to the first account and/or any data that could be used to determine such permissions. Implicit grants include any permissions implicitly granted to the user (e.g., resources under an explicitly granted resource, such as location 222 under location group 230 in the example of FIG. 2). Implicit grants are explained in more detail in U.S. Provisional Application No. 63/459,887, filed Apr. 17, 2023, and titled “Multi-User Media Playback System” and U.S. patent application Ser. No. 18/635,595, filed Apr. 15, 2024, and titled “MULTI-USER MEDIA PLAYBACK SYSTEM,” the contents of each of which are incorporated by reference in their entirety.

In some instances, block 354 can be conducted in response to, or based on, or after receiving certain kinds of data requests in block 352. Similarly, block 356 be conducted in response to, or based on, or after receiving certain kinds of data requests in block 352. Alternatively, any of blocks 354/356 can be performed independent of any request received in block 352. For example, the computing system could perform such blocks periodically or in response to certain events, such as when a change is detected (e.g., a change in the topology of one of the media playback systems). In some instances, method 350 comprises performing both blocks 354 and 356. In some instances, method 350 comprises performing only one of blocks 354 or 356.

In any instance, the data can be sent to the first account, as indicated in block 360. The data can be sent in response to the data request received in block 352.

In some instances, method 350 includes a block 358 of compiling the data. This block could include computing, selecting, organizing, and/or arranging the data determined in any of the previous blocks. This block could include generating a data structure comprising the data to be sent to the first account. The data structure can comprise a list of resource identifiers corresponding to the resources to which the first account has access. The data structure can comprise additional data such as an identifier of the media playback system to which the resources belong, an identifier of the account under which the resources are registered, a role for the first account in each of the systems/resources, etc.). The data provided in block 360 of flowchart 350 can be the data received by the first account in block 304 of flowchart 300. This data can be used to generate the user interfaces described with reference to blocks 306-314.

Certain embodiments described herein can be advantageous in that the data used to provide the user interfaces corresponding to each media playback system can be mined locally from a general data set (e.g., the data set received in block 304) so that additional data requests do not necessarily need to be sent to the computing system. This can facilitate switching between systems almost instantaneously without any potential delays related to sending data requests and receiving the data from the computing systems. Furthermore, in instances in which the computing system includes a third-party service to handle at least part of the data requests (e.g., an authentication service, or a service that handles/stored one or more of the associations disclosed above such as the system's topology), it may be necessary to compensate such third-party service for each request made. In this way, by minimizing the number of requests made to the computing system and computing the data locally on the device, any potential costs associated with processing multiple requests could be reduced. Furthermore, the computing system can act as an intermediary between the multiple services that manage different aspects of the data and handle authentication so that data for the various systems registered under other accounts can be provided. The first account, on the other hand, can take advantage by mining this data locally to obtain multiple sets of data for multiple purposes. Additionally, the computing system can provide the data to the first account without requiring additional login credentials from the user.

Additionally, by obtaining the source or “raw” data from the computing system it can be guaranteed that the first account is presented with the most up to date information and system state. For example, if a change in a system's topology affected the distribution of resources (e.g., a playback device was moved from one location to another) the user of the first account may be able to see the change reflected in the user interface.

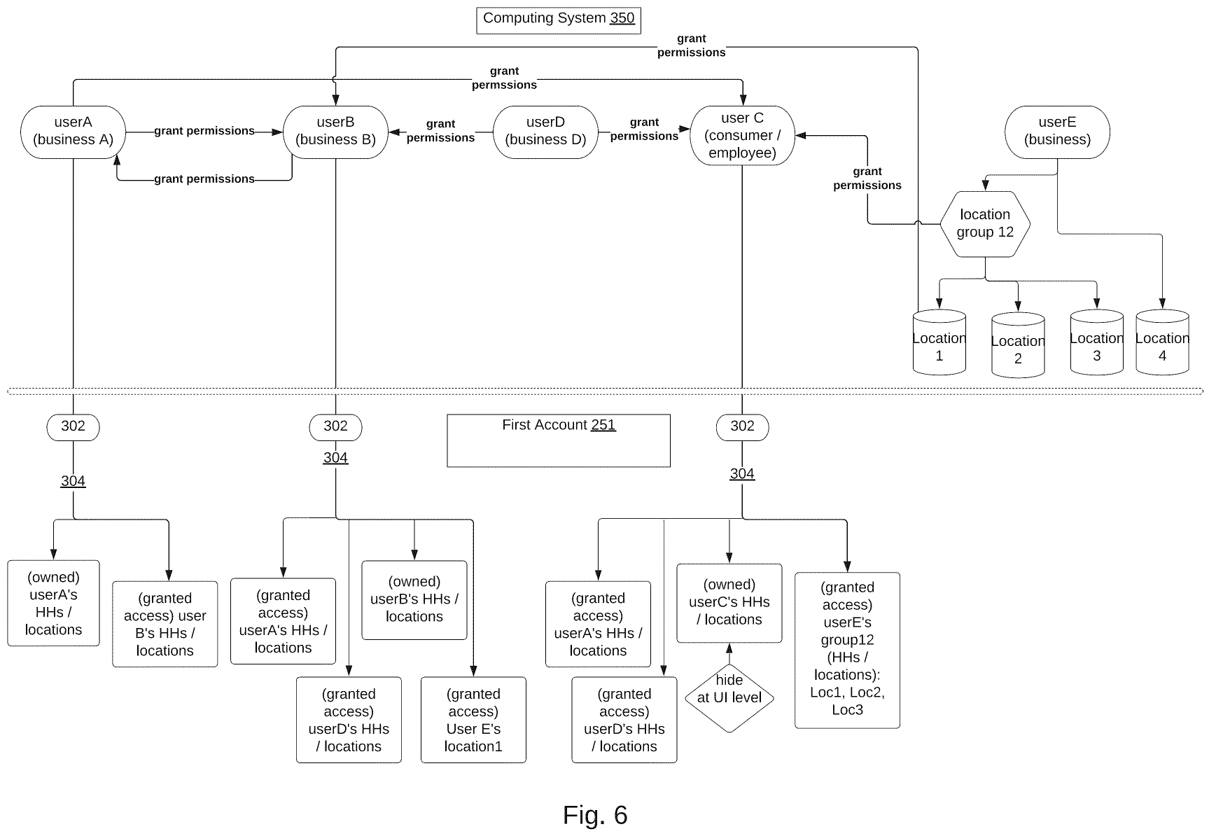

FIG. 6 illustrates a block diagram including example implementations of blocks 302 and 304 of method 300 of FIG. 3. In a first example, user A has been granted permissions on user B's system. In this way, a response (e.g., block 304 of method 300) to a request for data (e.g., block 302 of method 300) corresponding to the resources associated with user A may include a list of resources comprising user A's own resources in addition to user B's resources.

In a second example, user B has been granted permissions on user A's system, on user D's system and on one particular resource on user E's system (i.e., User E's location 1). In this way, the computing system may receive a request for data (e.g., block 302 of method 300) corresponding to the resources associated with user B and respond (e.g., block 304 of method 300) with a list of resources comprising user B's own resources in addition to user A's resources, user D's resources and user E's location 1.

In a third example, user C has been granted permissions on user A's system, on user D's system and on one particular resource on user E's system (i.e., User E's location group 12). In this way, a request for data (e.g., block 302 of method 300) corresponding to the resources associated with user C may be responded (e.g., block 304 of method 300) with a list of resources comprising user C's own resources in addition to user A's resources, user D's resources and user E's location group 12 and/or user E's locations 1, 2, and 3.

As represented in the block diagram of FIG. 6, the data related to each user and the relationship between them, the grants of permissions, the topology of the system, etc. can be stored, managed and/or otherwise accessible to the computing system 350. Different data may be stored and/or managed by different computing devices and/or services in the computing system. As explained before, this data may change due to a number of factors such as a change in the grants of permissions, a change in topology, etc. The computing system can be configured to obtain and compute such data in order to provide responses to data requests that reflect the most current state. The accounts that send the requests for data can then be provided with information that is relevant to the accounts and/or that the accounts are authorized to obtain without having to deal with the complexity behind the process.

As illustrated, the list of resources provided in the responses to the data requests may comprise resources from any system to which the user has access. In this way, processing (e.g., filtering) the data may be necessary in order to separate the data relevant to each system to provide the system selection mechanisms and various user interfaces described in this disclosure.

As mentioned before, certain data may be filtered out and not represented in a particular user interface. In the illustrated examples in FIG. 6, users A, B, and D correspond to an entity such as a business. User C corresponds to a person such as a consumer and/or employee. In some instances, user's C own resources may be excluded from the user interface (for example if the user interface is intended for professional use only).

As mentioned before in this disclosure, in some instances the first account can access/manage resources of different media playback systems based on a role of the account on those media playback systems. The role can define specific permissions on the resources accessible by the account. For example, an account may be granted access to a resource. A role for the account could define that the account is authorized to perform only certain operations or control certain functionalities (e.g., start/stop playback), but not others (e.g., select content for playback). In this way, there can be multiple levels of access control and/or permissions verification to determine what a particular account is authorized to do in a system. One such level could be based on any explicit/implicit grants to the account to determine what resources the additional account is authorized/not authorized to access. Another such level could be based on any role to determine what functionalities the account is allowed to access/control for the resources to which the account does have access. The roles for the account on each media playback system can also be provided by the computing system as part of the data received in block 304. Roles can change at any time (e.g., at a system owner discretion). In any case, the data received from the computing system would reflect the changes and therefore the user interface can be adapted to any specific permissions for the role (e.g., to add/remove playback controls).

In some instances, the accounts can access/manage resources using an access token. The access token can be specific to the account and/or to the resources the accounts have access to. In some instances, the token can be used to identify/authenticate the user/account when data requests are sent to the computing system. Furthermore, the token can identify a role for the account such that each additional account can access the resources it has been granted to subject to any respective role for the additional account. Example mechanisms for access control based on tokens and roles are described in U.S. Pat. Pub. 2022/0360585, filed May 9, 2022, entitled “Authorization Management in a Media Playback System”, which is incorporated by reference herein in its entirety.

In accordance with some examples described in this disclosure, a media playback system can be registered with a main account associated with (e.g., belongs to) a user or any other type of entity such as a business, a company, an organization, etc. The media playback system and/or corresponding main account can be in turn associated with additional accounts (such as first account 250b in the examples above) that are granted access to certain resources within the media playback system. Resources of a media playback system can include playback devices, groups of playback devices, partitions of the media playback system (or locations), groups of partitions or locations, etc.

In some instances, additional accounts are explicitly associated with and/or explicitly granted access to resources in the media playback system. The system can be configured to control access to a particular resource based on any access/permissions explicitly granted (explicit grants) to the account attempting to access the particular resource. The explicit grants can be established by the main account. For example, the main account can grant explicit access to a particular resource by identifying the particular resource via an invitation/onboarding process for the additional accounts or at any other time.

In some instances, additional accounts are implicitly associated with and/or implicitly granted access to resources in the media playback system. The system can be configured to control access to a particular resource based on any access/permissions implicitly granted (implicit grants) to the account attempting to access the particular resource. The implicit grants are not necessarily directly established by the main account and can instead be determined based on (e.g., derived from) any implicit grants and additional data available to the system. For example, the additional accounts can have implicit access to any resource associated with the particular resource they have been granted explicit access to, even if a direct association does not exist between the additional account and the ultimate resource it is trying to access (to which it has implicit access).

Implicit grants can be determined based on any data available to the system. In some instances, implicit grants are determined based on a topology of the media playback system. The topology of the media playback system can comprise any number of nodes corresponding to resources and/or group of resources in the media playback system. In this way, as resources are added, removed or changed within the system, the topology can be updated accordingly and any changes can be reflected in the implicit grants.

The system topology (or any other data used to determine implicit grants) can change dynamically based on a number of factors. The topology can change, for example, due to changes in the resources distribution within the system, when one or more partitions, locations and/or playback devices are added/removed in the media playback system, etc. In accordance with some embodiments described in this disclosure, the implicit grants could change accordingly even when the explicit grant originally established for a particular additional account remains the same.

The multi-user systems described in this disclosure could offer flexibility and scalability to a system with any number of playback devices and/or users. For example, a commercial establishment with a set of playback devices in a given partition/location could have a system administrator for their media playback system. The owner of the commercial establishment could grant the system administrator explicit access to the playback devices in the system. As the establishment grows (e.g., to a second floor) and more playback devices are installed, the system owner may need to grant access to the new playback devices to the administrator so that the administrator is authorized to access them. On the other hand, in accordance with some of the embodiments described herein, the system administrator could be granted explicit access to the location rather than to each playback device in the location. In this way, when playback devices are added to the location, the system administrator can already have implicit access to such devices. Similarly, if the location is eventually split into two or more locations (e.g., upstairs and downstairs), the system administrator could have implicit access to each of the new locations based on their explicit access to the original location.

Although most of the examples provided in this disclosure involve switching between different media playback systems, the teachings described herein can be more broadly applicable to any suitable environment. For example, similar techniques could be used to switch between partitions, locations, or locations groups of a same media playback system (e.g., associated with a same account). In this way, a user such as a business owner or a regional manager for the business could be able to switch between all the locations of the businesses to which the user has access. Furthermore, selecting a particular location would enable the user to control functionalities for the selected location, based on any role and resources assigned to the user on the particular location.

The flexibility provided by the techniques described herein allows the user to easily identify which system they are currently viewing, providing confidence that any changes will be made to the intended system. Furthermore, users can change the system they are viewing without having to log out and log back in, and may optionally not see their personal system on a dashboard if they are not a business subscriber.

An example scenario to help demonstrate the techniques described in this disclosure could include a first media playback system such as a system deployed at a Store and a second system such as system deployed at a Bakery. Haley owns the Store and is the super admin of the system. Chris owns the Bakery and is the super admin. Chris helps out Haley, and is also an admin at the Store. JJ works at both the Store and Brewery, and is an admin account at both. Ev works at only the Store and is an admin. Matt installed Sonos at both, the Dental Office, Restaurant, and many other businesses, and is an admin at every system he installs. Hadley doesn't work at any of these places, or anywhere at all. Each of these users would have only one account to view/access any system they have access to, and the user interface could vary for each of them based on their access. For example, Haley should just see the Store. Ev should just see the Store. Chris should see both. JJ should see both. Matt should see both, and maybe more. Hadley should see none. Other examples are possible.

In some embodiments, for example, a user device is provided. The user device comprises a display, at least one processor, and at least one non-transitory computer-readable medium comprising program instructions that are executable by the at least one processor such that the user device is configured to: transmit, to a computing system, a data request for data corresponding to partitions of media playback systems accessible by a first account of a media playback system provider; receive, from the computing system, a set of data comprising data corresponding to a set of partitions, wherein the partitions in the set of partitions comprise partitions of two or more media playback systems registered with two or more respective second accounts different than the first account, and wherein each partition comprises at least one playback device connected to a local area network (LAN) different than a LAN to which playback devices in other partitions are connected; display a first graphical user interface comprising a set of two or more first graphical representations respectively corresponding to the two or more media playback systems; receive an input corresponding to a selection of a particular graphical representation of the two or more first graphical representations, the particular representation corresponding to a particular media playback system of the two or more media playback systems; based on the input, identify a particular system identifier associated with the particular graphical representation; filter the set of data using the particular system identifier to obtain a filtered set of data; and display a second user interface, wherein the second user interface comprises a set of second graphical representations corresponding to a subset of partitions from the set of partitions, wherein the subset of partitions are partitions of the particular media playback system, and wherein the subset of partitions is indicated in the filtered set of data.

In some embodiments, for example, a non-transitory computer-readable medium is provided. The non-transitory computer-readable medium having stored thereon instructions executable by one or more processors to cause a user device to perform functions comprising: transmitting, to a computing system, a data request for data corresponding to partitions of media playback systems accessible by a first account of a media playback system provider; receiving, from the computing system, a set of data comprising data corresponding to a set of partitions, wherein the partitions in the set of partitions comprise partitions of two or more media playback systems registered with two or more respective second accounts different than the first account, and wherein each partition comprises at least one playback device connected to a local area network (LAN) different than a LAN to which playback devices in other partitions are connected; displaying a first graphical user interface comprising a set of two or more first graphical representations respectively corresponding to the two or more media playback systems; receiving an input corresponding to a selection of a particular first graphical representation of the two or more first graphical representations, the particular first representation corresponding to a particular media playback system of the two or more media playback systems; based on the input, identifying a particular system identifier associated with the particular graphical representation; filtering the set of data using the particular system identifier to obtain a filtered set of data; and displaying a second user interface, wherein the second user interface comprises a set of second graphical representations corresponding to a subset of partitions from the set of partitions, wherein the subset of partitions are partitions of the particular media playback system, and wherein the subset of partitions is indicated in the filtered set of data.

In some embodiments, for example, a method to be performed by a user device is provided. The method comprises: transmitting, to a computing system, a data request for data corresponding to partitions of media playback systems accessible by a first account of a media playback system provider; receiving, from the computing system, a set of data comprising data corresponding to a set of partitions, wherein the partitions in the set of partitions comprise partitions of two or more media playback systems registered with two or more respective second accounts different than the first account, and wherein each partition comprises at least one playback device connected to a local area network (LAN) different than a LAN to which playback devices in other partitions are connected; displaying a first graphical user interface comprising a set of two or more first graphical representations respectively corresponding to the two or more media playback systems; receiving an input corresponding to a selection of a particular first graphical representation of the two or more first graphical representations, the particular first representation corresponding to a particular media playback system of the two or more media playback systems; based on the input, identifying a particular system identifier associated with the particular graphical representation; filtering the set of data using the particular system identifier to obtain a filtered set of data; and displaying a second user interface, wherein the second user interface comprises a set of second graphical representations corresponding to a subset of partitions from the set of partitions, wherein the subset of partitions are partitions of the particular media playback system, and wherein the subset of partitions is indicated in the filtered set of data.

In some embodiments, the partitions in the set of partitions further comprise at least one partition of a media playback system registered with the first account.

In some embodiments, displaying the first graphical user interface comprises displaying, along with the set of two or more graphical representations respectively corresponding to the two or more media playback systems, an additional graphical representation corresponding to the media playback system registered with the first account.

In some embodiments, the first graphical user interface comprising the set of two or more graphical representations respectively corresponding to the two or more media playback systems excludes a graphical representation corresponding to the media playback system registered with the first account.

In some embodiments, the second user interface facilitates control, over a wide area network (WAN), of at least one functionality for at least one playback device in the subset of partitions.

In some embodiments, the second user interface facilitates control, over a wide area network (WAN), of at least one functionality for playback devices in at least one partition in the subset of partitions.

In some embodiments, the second user interface facilitates control, over a wide area network (WAN), of at least one functionality for playback devices in all partitions in the subset of partitions.

In some embodiments, the second user interface facilitates control, over a wide area network (WAN), of at least one functionality for the subset of partitions using an access token associated with the particular media playback system.

In some embodiments, the subset of partitions are partitions of the particular media playback system to which the first account has access.

In some embodiments, the particular media playback system comprises the at least one partition to which the first account does not have access.

In some embodiments, the subset of partitions excludes the at least one partition.

### IV. Conclusion

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

1. A user device comprising:
a display;
at least one processor; and
at least one non-transitory computer-readable medium comprising program instructions that are executable by the at least one processor such that the user device is configured to:
transmit, to a computing system, a data request for data corresponding to partitions of media playback systems accessible by a first account of a media playback system provider;
receive, from the computing system, a set of data comprising data corresponding to a set of partitions, wherein the partitions in the set of partitions comprise partitions of two or more media playback systems registered with two or more respective second accounts different than the first account, and wherein each partition comprises at least one playback device connected to a local area network (LAN) different than a LAN to which playback devices in other partitions are connected;
display a first graphical user interface comprising a set of two or more first graphical representations respectively corresponding to the two or more media playback systems;
receive an input corresponding to a selection of a particular first graphical representation of the set of two or more first graphical representations, the particular first graphical representation corresponding to a particular media playback system of the two or more media playback systems;
based on the input, identify a particular system identifier associated with the particular first graphical representation;
filter the set of data using the particular system identifier to obtain a filtered set of data; and
display a second user interface, wherein the second user interface comprises a set of second graphical representations corresponding to a subset of partitions from the set of partitions, wherein the subset of partitions are partitions of the particular media playback system, and wherein the subset of partitions is indicated in the filtered set of data.

2. The user device of claim 1, wherein the partitions in the set of partitions further comprise at least one partition of a media playback system registered with the first account.

3. The user device of claim 2, wherein displaying the first graphical user interface comprises displaying, along with the set of two or more first graphical representations respectively corresponding to the two or more media playback systems, an additional graphical representation corresponding to the media playback system registered with the first account.

4. The user device of claim 2, wherein the first graphical user interface comprising the set of two or more first graphical representations respectively corresponding to the two or more media playback systems excludes a graphical representation corresponding to the media playback system registered with the first account.

5. The user device of claim 1, wherein the second user interface facilitates control, over a wide area network (WAN), of at least one functionality for at least one playback device in the subset of partitions.

6. The user device of claim 1, wherein the second user interface facilitates control, over a wide area network (WAN), of at least one functionality for playback devices in at least one partition in the subset of partitions.

7. The user device of claim 1, wherein the second user interface facilitates control, over a wide area network (WAN), of at least one functionality for playback devices in all partitions in the subset of partitions.

8. The user device of claim 1, wherein the second user interface facilitates control, over a wide area network (WAN), of at least one functionality for the subset of partitions using an access token associated with the particular media playback system.

9. The user device of claim 1, wherein the subset of partitions are partitions of the particular media playback system to which the first account has access.

10. The user device of claim 9, wherein the particular media playback system comprises at least one partition to which the first account does not have access.

11. The user device of claim 10, wherein the subset of partitions excludes the at least one partition.

12. A non-transitory computer-readable medium having stored thereon instructions executable by one or more processors to cause a user device to perform functions comprising:
transmitting, to a computing system, a data request for data corresponding to partitions of media playback systems accessible by a first account of a media playback system provider;
receiving, from the computing system, a set of data comprising data corresponding to a set of partitions, wherein the partitions in the set of partitions comprise partitions of two or more media playback systems registered with two or more respective second accounts different than the first account, and wherein each partition comprises at least one playback device connected to a local area network (LAN) different than a LAN to which playback devices in other partitions are connected;
displaying a first graphical user interface comprising a set of two or more first graphical representations respectively corresponding to the two or more media playback systems;
receiving an input corresponding to a selection of a particular first graphical representation of the set of two or more first graphical representations, the particular first graphical representation corresponding to a particular media playback system of the two or more media playback systems;
based on the input, identifying a particular system identifier associated with the particular first graphical representation;
filtering the set of data using the particular system identifier to obtain a filtered set of data; and
displaying a second user interface, wherein the second user interface comprises a set of second graphical representations corresponding to a subset of partitions from the set of partitions, wherein the subset of partitions are partitions of the particular media playback system, and wherein the subset of partitions is indicated in the filtered set of data.

13. The non-transitory computer-readable medium of claim 12, wherein the partitions in the set of partitions further comprise at least one partition of a media playback system registered with the first account.

14. The non-transitory computer-readable medium of claim 13, wherein displaying the first graphical user interface comprises displaying, along with the set of two or more first graphical representations respectively corresponding to the two or more media playback systems, an additional graphical representation corresponding to the media playback system registered with the first account.

15. The non-transitory computer-readable medium of claim 13, wherein the first graphical user interface comprising the set of two or more first graphical representations respectively corresponding to the two or more media playback systems excludes a graphical representation corresponding to the media playback system registered with the first account.

16. The non-transitory computer-readable medium of claim 12, wherein the second user interface facilitates control, over a wide area network (WAN), of at least one functionality for at least one playback device in the subset of partitions.

17. The non-transitory computer-readable medium of claim 12, wherein the second user interface facilitates control, over a wide area network (WAN), of at least one functionality for playback devices in at least one partition in the subset of partitions.

18. The non-transitory computer-readable medium of claim 12, wherein the second user interface facilitates control, over a wide area network (WAN), of at least one functionality for playback devices in all partitions in the subset of partitions.

19. The non-transitory computer-readable medium of claim 12, wherein the second user interface facilitates control, over a wide area network (WAN), of at least one functionality for the subset of partitions using an access token associated with the particular media playback system.

20. A method to be performed by a computing device, the method comprising:
transmitting, to a computing system, a data request for data corresponding to partitions of media playback systems accessible by a first account of a media playback system provider;
receiving, from the computing system, a set of data comprising data corresponding to a set of partitions, wherein the partitions in the set of partitions comprise partitions of two or more media playback systems registered with two or more respective second accounts different than the first account, and wherein each partition comprises at least one playback device connected to a local area network (LAN) different than a LAN to which playback devices in other partitions are connected;
displaying a first graphical user interface comprising a set of two or more first graphical representations respectively corresponding to the two or more media playback systems;
receiving an input corresponding to a selection of a particular first graphical representation of the set of two or more first graphical representations, the particular first graphical representation corresponding to a particular media playback system of the two or more media playback systems;
based on the input, identifying a particular system identifier associated with the particular first graphical representation;
filtering the set of data using the particular system identifier to obtain a filtered set of data; and
displaying a second user interface, wherein the second user interface comprises a set of second graphical representations corresponding to a subset of partitions from the set of partitions, wherein the subset of partitions are partitions of the particular media playback system, and wherein the subset of partitions is indicated in the filtered set of data.
